(19) United States
(12) Patent Application Publication
(10) Pub. No.: US 2003/0078008 A1
(43) Pub. Date: Apr. 24, 2003

(54) Method,communications system and receiver for transmitting data in packet form

(75) Inventors: Thomas Gruhn, Berlin (DE); Christina Gessner, Munchen (DE); Frank Hillebrand, Berlin (DE); Lutz Jarbot, Berlin (DE); Reinhard Koehn, Berlin (DE); Gerald Lehmann, Berlin (DE); Georgios Papoutsis, Berlin (DE); Juergen Schindler, Berlin (DE); Joerg Schniedenham, Berlin (DE); Armin Sitte, Berlin (DE); Frank Wagner, Berlin (DE)

Correspondence Address: STAAS & HALSEY LLP, 700 11TH STREET, NW, SUITE 500, WASHINGTON, DC, 20001, US

(73) Assignee: Siemens Aktiengesellschaft, Munich (DE)

(21) Appl. No.: 10/204,035

(22) PCT Filed: Feb. 16, 2001
(86) PCT No.: PCT/DE01/00624

(30) Foreign Application Priority Data
Feb. 18, 2000 (DE) 10007564.9

(51) Int. Cl. H04B 17/00; H04Q 7/00

(52) U.S. Cl. 455/67.1; 370/313

(57) ABSTRACT

A method of operating a high speed, error-free data transmission system in a noisy medium includes compressing data determined to be compressible, forward error correcting the data and interleaving the data in a bit matrix memory to enhance the forward error correction. Digital information packets are formulated including a header bearing a packet number, the total packet byte count, any packet number resend request, the data byte count of the actual data and a CRC. The digital information packet is loaded onto a transmitter carousel having a fixed number of sectors. The receiver receives the data, requests resend of any packet (by number) that is defective, error corrects if necessary and sequentially loads the packet onto a receiver carousel. Packets or sequential packet groups are removed from the carousel, selectively decompressed and the data words extracted and sent to the output.

### DESCRIPTION

Method, communications system and receiver for transmitting data in packet form

The invention relates to a method, a communications system and a receiver for the transmission of data packets.

In digital radio communications systems, data is often sent in packets (PDUs), which are provided with an identification number (sequence number, also called an “identifier” in the following). Especially for so-called ARQ (Automatic Repeat Request) error correction methods, sequence numbers are used to enable the receiver end to request supplementary information to correct incorrectly transmitted packets.

In the following text, the datasets sent in each case, which separately or by suitable combination serve for reconstruction of the packet data at the receiver end, are called “coding units”. This refers to the data packets to be transferred in coded form.

In the so-called Hybrid ARQ I method, the receiver end informs the sending station directly or indirectly of the sequence numbers of the unsuccessfully decoded coder units, which are then sent again by the sending station.

In the so-called Hybrid ARQ II or Hybrid ARQ III method, an incorrectly received (first) coding unit is linked with additional information (2^{nd}, 3^{rd}, . . . , nth coding unit) subsequently requested from the sender, in order to recover the data packet. For example, with Hybrid ARQ II/III methods, the coding units can involve coding polynomials, which for instance are further processed using rate-matching methods.

As well as the combination of various coding units belonging to a data packet, previously sent coding units can also be transmitted once more and combined using maximum ratio combining with the version already sent.

Previously sent or dispatched coding units can also be dispatched once more and be combined by means of a combination process in the best possible ratio (maximum ratio combining) with the version already sent.

To ensure using Hybrid ARQ II/III or similar methods that the coding units combined for decoding belong to the same data packet, it is very important that for a faulty data packet transmission the receiver can at least check whether it has received the sequence number correctly. Such a check can be made with the help of a CRC (=Cyclic Redundancy Check) using appropriately added checksum bits, for example. If a sequence number has not been correctly received at the receiver end, or if the correctness of the sequence number could not be successfully checked (for example because a CRC was incorrectly transmitted), then the coding unit can no longer be used with the previously used methods to support the decoding of the associated data packet in combination with other coding units.

If one were nonetheless to use a coding unit for which the correctness of the sequence number could not be confirmed (this case is also referred to in the following as “identifier not identifiable by the receiver”) for a combination with another coding unit, there is a danger with the previously used methods of coding units not belonging to the same data packet being combined. It is very probable however that any decoding attempt that includes a coding unit not belonging to the data packet will be unsuccessful. This may result in all subsequent attempts to decode the data packet using new coding units being unsuccessful. Consequently, with the previously used methods, a coding unit whose sequence number or identifier is unclear on the receiving side can usually not be used for decoding.

In Braneci M. et al., IEEE International Conference on Communications, Jul. 6, 1997, pages 1068-1072, an ARQ Type II method is described in which data packets are equipped by the transmitter with control information. If a data packet cannot be correctly decoded by the receiver, it sends a negative acknowledgement signal (NACK) to the transmitter. In the event that the control information does not arrive at the receiver because of erasure, the negative acknowledgement signal is likewise sent. The receiver stores the associated coding unit and requests coding units of the last requested data packet until control information is recognized. All coding units whose control information was not yet recognized are stored. By an exclusion process, those stored coding units that can certainly be assigned to the coding unit with the recognized control information are combined with this. All other coding units are discarded without attempted combination.

The invention is based on the object of improving the decoding in the receiver of data packets coded into coding units.

This object is achieved with the method as claimed in claim 1, the radio communications system as claimed in claim 16 and the receiver as claimed in claim 17. Advantageous embodiments and developments of the invention are the subject matter of the dependent claims.

The method according to the invention for transmitting data in packet form between a transmitter and a receiver provides, in the event that one of the identifiers of the coding units cannot be identified by the receiver, that the corresponding coding unit is stored in the receiver for later decoding, which takes place using data to be transmitted subsequently by the transmitter.

The invention also advantageously provides those coding units for decoding whose identifiers were defectively received or the correctness of whose received identifier could not be successfully confirmed. By the use of the coding units already transmitted in any case, a repeated transmission is avoided, so that less data need be transmitted in total.

The use of the stored coding unit of a data packet for decoding can in particular occur in that a further coding unit of the same data packet is transmitted from the transmitter to the receiver, the stored coding unit is combined in the receiver with the further coding unit, and the combination of these coding units is then decoded. The combining of the coding units can for example take place as in the Hybrid ARQ II or Hybrid ARQ III methods.

A development of the invention provides that the receiver stores the further coding unit, before the combination of the coding units decodes the further coding unit without using the stored coding unit, and carries out the combination with the stored coding unit and the decoding of the combination only in the event of incorrect decoding of the further coding unit. There is thus first a trial of whether the decoding of the further coding unit is successful alone. In some circumstances this can make the combination of the two coding units unnecessary.

According to a development, several coding units with unidentifiable identifier are stored in the receiver. In the event of incorrect decoding of the combination of the further coding unit and one of the stored coding units, the further coding unit is combined with another of the stored coding units, and this combination is then decoded. This method makes it possible to determine which stored coding unit is assigned to the same data packet as the further coding unit.

Upon successful identification of the identifier of the coding units, the receiver can also transmit corresponding acknowledgement signals to the transmitter, which permit the relevant identifier to be deduced, and the transmitter, by comparing the received acknowledgement signals with the identifiers of the previously transmitted coding units, can determine for which of the transmitted coding units the identifier could not be identified. The acknowledgement signals can in particular be conventionally used acknowledge/not acknowledge signals, which are also used in the known ARQ methods. Compared to these methods, this does not lead to an increased signaling cost for the invention.

However, the receiver can also, additionally or alternatively to the acknowledgement signals for the coding units with identifiable identifiers, transmit corresponding information to the transmitter if it could not identify the identifier of a received coding unit. This enables the transmitter to find out about a fault without having undertaken an analysis of the acknowledgement signals.

According to a development, the receiver informs the transmitter how many received coding units during a certain receiving period have an identifier that it cannot identify. The transmitter thereby knows how many data packets were not correctly received.

The receiver can also inform the transmitter for which of the data packets to be received by said receiver it was unable to identify a coding unit with the relevant identifier. For this, it is necessary that the receiver is informed about which data packets and associated identifiers it should have received. It is advantageous that the transmitter can then immediately send further coding units to the receiver for each of the specified data packets.

The information transmitted by the receiver to the transmitter can also include such information as will enable a further limitation of the possibly incorrectly transmitted coding units on the transmitter end. For example, the information can state the time at which or period during which the coding unit with the unidentifiable identifier was received. For a TDMA method (this also includes transmission methods with a TDMA component) this can involve notification of the time frame number (SFN) or time slot number in which the stored coding unit was received.

If the data packets are transmitted using a CDMA method (this also includes transmission methods with a CDMA component), the information can also state the spread-spectrum code with which the coding unit with the unidentifiable identifier is coded.

If the data packets are transmitted using an FDMA method (this also includes transmission methods with an FDMA component), the information can also state the carrier frequency with which the coding unit with the unidentifiable identifier was transmitted.

The information can also include at least a segment of the coding unit with the unidentifiable identifier, or a segment of a header section of this coding unit. Using this segment, the transmitter may then under certain circumstances be able to identify the coding unit stored in the receiver, and transmit a corresponding further coding unit for the same data packet.

According to a development of the invention, for at least a part of the data packets, several different coding units are formed on the transmitter end in each case, differing in their code rates and with different identification numbers assigned to them. The information then advantageously contains the identification number of the coding unit with the unidentifiable identifier.

It is beneficial if the transmitter notes the identifiers of the further coding units that it transmits to the receiver. It is thereby possible for it to avoid transmitting this same further coding unit again at a later time.

The transmitter can note the order of transmission of the coding units, and the receiver can note the order of receipt of the coding units equipped with unidentifiable identifier. If the transmitter then transmits the further coding units in the same order in relation to their assignment to the data packets as the originally transmitted coding units with the unidentifiable identifiers, the assignment in the receiver of the further coding units to the stored coding units with unidentifiable identifier is simplified.

It is sensible if the transmitter, in addition to the further coding unit, transmits an information item to the receiver that states that the further coding unit is assigned to a data packet whose identifier was not so far identifiable by the receiver. This enables the receiver to distinguish the further coding units from other coding units, which for example are being transmitted as the chronologically first coding units of a data packet. It is only for the further coding units that a combination with the stored coding units is desired.

The invention will be further described with reference to examples of embodiments shown in the drawings, in which:

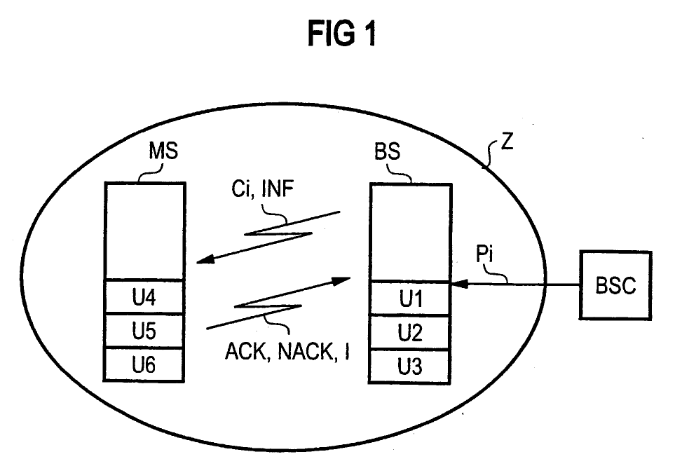

FIG. 1 shows a segment of the communications system according to the invention with a transmitter and a receiver,

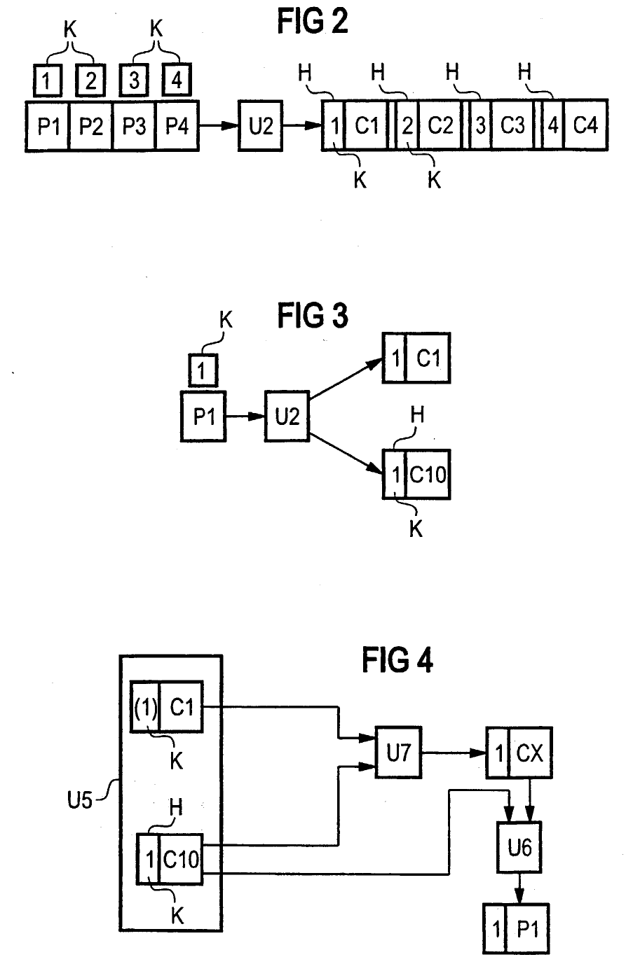

FIG. 2 shows the coding of data packets into coding units,

FIG. 3 shows the coding of one data packet into several different coding units and

FIGS. 4 to 6 show different decodings of coding units in the receiver.

The invention will be further described with reference to a mobile radio communications system, although it is also applicable to other communications systems, in which packet data transmission takes place.

FIG. 1 shows a radio cell Z of a mobile radiotelephone system. The radio cell Z has a base station BS and a mobile station MS. In the following, only a data transfer in the downlink, i.e. from the base station to the mobile station, is considered. However, the invention is equally applicable to the data transfer in the uplink. In the following, the base station is thus considered in its property as transmitter, and the mobile station in its property as receiver.

The base station BS receives from a base station controller BSC data Pi, which it intends to transmit in packet form to the mobile station MS. The base station presents a unit U1 for assigning an identifier to each of the data packets Pi, to identify their order during the transmission. The base station also has a unit U2 for coding the data packets Pi into coding units Ci. From a unit U3, the coded data packets Pi are transmitted to the mobile station MS in the form of coding units Ci, provided with the relevant identifier. Within the scope of this description, the term “coding unit” denotes information or redundancy quantities generated from the data packets Pi, which at the receiver end, either individually or by suitable linking with other coding units, enable recovery of the data packets Pi.

The mobile station MS in FIG. 1 has a unit U4 for evaluation of the identifier of each coding unit Ci that it receives. The mobile station MS further has a memory U5 for storing those coding units Ci whose identifier cannot be identified by the evaluation unit U4. This is the case when the identifier concerned was exposed to major interference during the transmission. The mobile station MS further has a decoder U6, which is used for decoding the coding units Ci.

FIG. 2 shows the coding of the data packets Pi into the coding units Ci. FIG. 2 also shows the identifiers K assigned to the data packets Pi. The coder unit U2 of the base station BS generates at its output the coding units Ci, which it prefixes in a header section H with the corresponding identifier K of the associated data packet Pi. While the mobile station MS in FIG. 1 stores in the memory U5 those received coding units Ci whose identifier could not be identified, it decodes the other coding units whose identifier is identifiable without problems. Since the coding of the data packets Pi takes into account the use of appropriate error correction codes (for example Cyclic Redundancy Check, CRC, with corresponding checksum bits), it can be detected in the mobile station whether the relevant decoding has taken place with or without faults. The mobile station MS then transmits corresponding acknowledgement signals ACK, NACK to the base station BS. The one acknowledgement signal ACK indicates that the corresponding coding unit Ci could be successfully decoded, while the second acknowledgement signal NACK indicates that the associated coding unit Ci with the corresponding identifier has been received, but the decoding was faulty. In the latter case, the base station BS can repeat the transmission of the coding unit concerned in a known manner (e.g. by a known ARQ method), or transmit another coding unit of the same data packet.

Based just on the acknowledgement signals ACK, NACK, the base station BS can detect that those coding units Ci for which no corresponding acknowledgement signal has been received have either not been received by the mobile station MS, or have been received but had an identifier K that could not be identified by the receiver.

In the embodiment described here, the mobile station MS also transmits information I to the base station BS, in addition to the acknowledgement signals ACK, NACK. The information I serves to assist the base station BS in detecting for which of the transmitted coding units Ci the associated identifier K could not be identified in the receiver. The information I could for example contain the number of coding units Ci received with unidentifiable identifier K within a certain receiving period. It is also possible for the information I to contain those identifiers K to which none of the received coding units Ci could be assigned. This is possible if the mobile station knows which identifiers it should have received within a certain period.

To support the base station BS in detecting which of the previously transmitted coding units Ci have had an identifier K that could not be identified in the mobile station MS, the information I can also indicate with which carrier frequency, with which spread-spectrum code, or at which time or during which period the coding unit with the unidentifiable identifier K was received. It is naturally possible to state the spread-spectrum code only if a CDMA transmission method is involved. The period for such reception can be stated e.g. for TDMA transmission methods in the form of the number of the reception time frame or reception time slot.

The base station BS (or generally: the sender) sends further coding units to the mobile station MS after detecting for which of the previously transmitted coding units Ci an identification of the associated identifier K was not possible in the mobile station MS. Using the coding units with an unidentifiable identifier stored in the mobile station MS, the further coding units serve to enable error-free decoding and thus determination of the underlying data packet Pi in the receiver. The base station BS provides the further coding units transmitted by it to the mobile station MS with a corresponding identification INF. From the identification INF, the mobile station MS can infer that a coding unit with unidentifiable identifier K has previously been transmitted for the associated data packet Pi.

FIG. 3 shows that, with different codings, the coding unit U2 of the base station BS can generate several different coding units C1, C2 from one data packet P1. In this case such a coding method includes the use of error correction codes as well as for example spread-spectrum codes, provided a CDMA transmission method is involved. In the case shown in FIG. 3, the coder U2 generates (though possibly at different times, see below) two different coding units C1, C2 for the data packet P1. The two coding units C1, C10 differ in their code rates. Coding unit C1 has code rate 1, while coding unit C2 has the code rate 0.5.

The base station BS initially generates only the first coding unit C1 for the data packet P1, and transmits this with the coding units of the other data packets Pi to the mobile station MS. Only if the base station BS finds out that the identifier K of the first coding unit C1 could not be identified by the mobile station MS, and was stored in its memory U5, does the coder U2 of the base station BS generate the further coding unit C10 from the data packet PI. The base station BS then also transmits the further coding unit C10 to the mobile station MS.

With reference to the following figures, the manner in which the data packet PI is then decoded in the mobile station MS from the received coding units is now described.

FIG. 4 shows the case where both the coding units C1, C10 assigned to the data packet P1 have already been stored in the memory U5 of the mobile station MS. In FIG. 4 and the subsequent figures, a bracket round the identifier K of the respective coding unit Ci indicated that the relevant identifier K could not be identified by the receiver. The decoder U6 of the mobile station MS first decodes the further coding unit C10. If this decoding is successful, which can be ascertained by evaluation of the error correction codes used, the data packet PI has been correctly reconstructed in the receiver. The two coding units C1, C10 in the memory U5 can then be deleted. For the case where the decoding of the further coding unit C10 by the decoder U6 was not successful, the mobile station MS has a combination unit U7, which combines the coding units C1, C10 together to form a combined coding unit CX. The combined coding unit CX is then decoded by the decoder U6. In this manner, using both the originally transmitted coding unit C1 with the unidentifiable identifier K and the further coding unit C10, the correct data packet P1 can be determined in the receiver. The combination of the coding units can for example be as in corresponding combinations for the Hybrid ARQII or ARQIII methods.

FIG. 5 shows the case that in the memory U5 of the mobile station MS, two coding units C1, C2 with unidentifiable identifier K were stored. The base station BS has accordingly transmitted a further coding unit C10, C20 for each affected data packet P1, P2 to the mobile station MS. As shown in FIG. 5, because of the fact that the identifier K of the coding units C1, C2 is unknown, it can happen that the combination unit U7 first combines the further coding unit C10 of the first data packet Pi with the coding unit C2 of the second data packet P2 to form a combined coding unit CX. This incorrectly executed combination CX is then decoded by the decoder U6. Using the applied error correction code, it can then be detected that the decoding result is wrong.

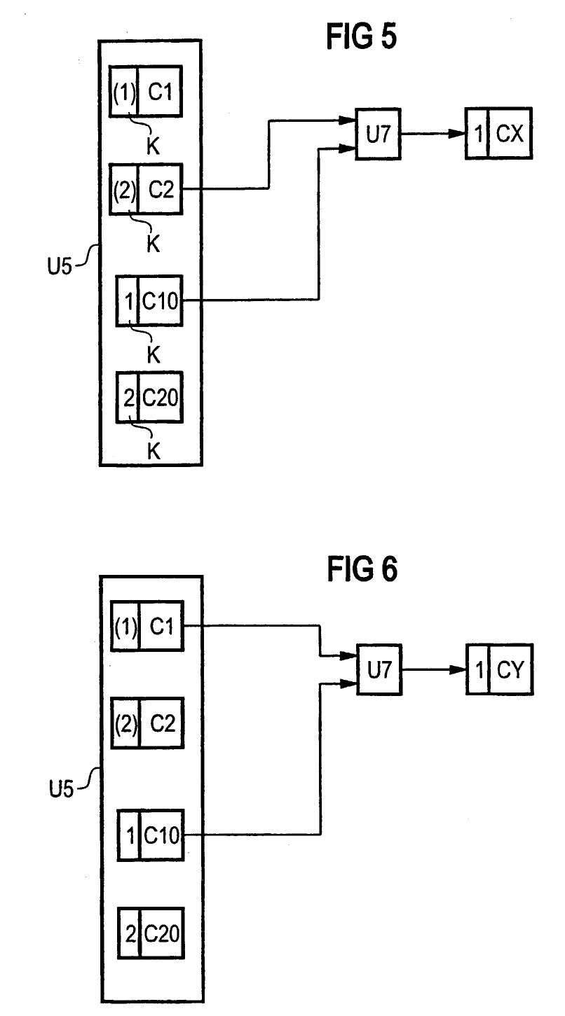

According to FIG. 6, a new combination of the further coding unit C10 is thereupon formed, this time with the coding unit C1 of the first data packet Pi. The combination unit U7 generates a corresponding combined coding unit CY. This is turn is fed to the decoder U6, whose output signal this time corresponds to the data packet P1. In a further step (not shown in the figures), the further coding unit C20 of the second data packet P2 can then be combined with the coding unit C2 of the second data packet P2 and decoded. Before this the coding units C1, C10, which are now no longer needed, can be deleted.

The invention makes it possible that for Hybrid ARQ II/III or similar error correction methods, transmitted coding units for which the identification of the sequence number/coding number was unsuccessful can also be included. As a result, a greater susceptibility to transmission faults is tolerable for coding units in relation to their identifier. Optimal usage is made of the information transmitted over the air interface.

As a simultaneous acknowledgement signal, the information I (FIG. 1) transmitted by the mobile station MS may for example be in the form of a bit pattern and a start identifier SSN. For example, two bits are always assigned to each data packet, the first two bits concerning the data packet with the identifier SSN, the next two the data packet with the identifier SSN+I and so on. The following meanings can now be determined, for example, for the bit pattern:

00: no coding unit has been received for the sequence number concerned.

01: coding unit was successfully received (corresponds to the ACK signal).

10: coding unit was received for the sequence number concerned, but cannot be decoded (corresponds to the NACK signal).

11: (not used).

As information I (i.e. with the reporting of an unidentified coding unit) the receiver in FIG. 1 can also send a segment from the unidentified coding unit, which serves on the transmitter end for deciding which data packet the unidentified coding unit could come from. If several coding units are possible, the transmitter can compare this data fragment with the corresponding points in the possible coding units, and choose the coding unit that matches best in this comparison.

Transmitter and receiver can also note the time frame number of the transmitted coding units and of the received and unidentifiable coding units. The receiver now informs the transmitter about how many coding units were received unidentified in which time frame, i.e. for which SFN number. The number of transmitted coding units per frame is generally much smaller than the number of transmitted coding units between two status reports, in which the acknowledgement signals ACK, NACK are usually transmitted. Correspondingly, the number of unidentified coding units per time frame is on average also smaller than the number of unidentified coding units between two status reports. This greatly simplifies the assignment of the further coding units to the previously received stored coding units with failed identification of the identifier, and the number of cases in which the assignment is unique is increased.

1. A method for transmitting data in packet form between a transmitter (BS) and a receiver (MS),
in which
the data packets (Pi) are each assigned an identifier (K) to identify their order,
each data packet (Pi) is coded into a coding unit (Ci),
each coding unit (Ci) is transmitted from the transmitter (BS) to the receiver (MS) with the identifier (K) of the associated data packet (Pi),
an evaluation of the associated identifier (K) takes place in the receiver (MS) for each coding unit (Ci),
in the event that one of the identifiers (K) cannot be identified, the corresponding coding unit (Cl) is stored in the receiver (MS) for later decoding, which takes place using data to be transmitted subsequently by the transmitter (BS)
and the receiver (MS) transmits a corresponding information item (I) to the transmitter (BS), from which it can be inferred that it could not identify the identifier (K) of a received coding unit (Cl).

2. The method as claimed in claim 1,
in which
a further coding unit (C10) of a data packet (P1), whose coding unit (C1) has already been transmitted, is transmitted from the transmitter (BS) to the receiver (MS),
the stored coding unit (C1) is combined in the receiver with the further coding unit (C10)
and the combination (CX) of these coding units is decoded.

3. The method as claimed in claim 2,
in which the receiver (MS) stores the further coding unit (C10),
before the combination of the coding units (C1, C10), decodes the further coding unit (C10) without using the stored coding unit (C1),
and carries out the combination (CX) with the stored coding unit (C1) and the decoding of the combination only in the event of incorrect decoding of the further coding unit (C10).

4. The method as claimed in claim 2 or 3,
in which
several coding units (C1, C2) with unidentifiable identifier (K) are stored in the receiver (MS),
in the event of incorrect decoding of the combination (CX) of the further coding unit (C10) and one of the stored coding units (C2), the further coding unit is combined with another (C1) of the stored coding units,
and this combination (CY) is decoded.

5. The method as claimed in one of the preceding claims, in which
the receiver (MS), upon successful identification of the identifier (K) of the coding units (Ci), transmits corresponding acknowledgement signals (ACK, NACK) to the transmitter (BS), which permit the relevant identifier to be deduced,
and the transmitter (BS), by comparing the received acknowledgement signals (ACK, NACK) with the identifiers (K) of the previously transmitted coding units (Ci), determines for which of the transmitted coding units the identifier could not be identified.

6. The method as claimed in one of the preceding claims,
in which the receiver (MS) informs the transmitter (BS) how many received coding units (C1, C2) during a certain receiving period have an identifier (K) that is not identifiable.

7. The method as claimed in one of the preceding claims,
in which the receiver (MS) informs the transmitter (BS) for which of the data packets (Pi) to be received by said receiver it was unable to identify a coding unit (Ci) with the relevant identifier (K).

8. The method as claimed in one of the preceding claims,
in which the information (I) states the time at which or period during which the coding unit (C1) with the unidentifiable identifier (K) was received.

9. The method as claimed in one of the preceding claims,
in which
the data packets (Pi) are transmitted using a CDMA method,
and the information (I) states the spread-spectrum code with which the coding unit (C1) with the unidentifiable identifier (K) is coded.

10. The method as claimed in one of the preceding claims,
characterized in that
the data packets (Pi) are transmitted using an FDMA method,
and the information (I) states the carrier frequency with which the coding unit (C1) with the unidentifiable identifier (K) was transmitted.

11. The method as claimed in one of the preceding claims,
in which the information (I) includes at least a segment of the coding unit (C1) with the unidentifiable identifier (K), or a segment of a header section (H) of this coding unit.

12. The method as claimed in one of the preceding claims, in which
for at least a part (P1) of the data packets (Pi), several different coding units (C1, C10) are formed in each case, differing in their code rates and with different identification numbers assigned to them,
and the information (I) contains the identification number of the coding unit with the unidentifiable identifier.

13. The method as claimed in one of the preceding claims, in which the transmitter (BS) notes the identifiers (K) of the further coding units (C10) that it transmits to the receiver (MS).

14. The method as claimed in one of the preceding claims,
in which
the transmitter (BS) notes the order of transmission of the coding units (Ci),
the receiver (MS) notes the order of receipt of the coding units (C1, C2) equipped with unidentifiable identifier (K),
and the transmitter (BS) then transmits the further coding units (C10) in the same order in relation to their assignment to the data packets (Pi) as the originally transmitted coding units (C1) with the unidentifiable identifiers (K).

15. The method as claimed in one of the preceding claims, in which the transmitter (BS), in addition to the further coding unit (C10), transmits an information item (INF) to the receiver (MS) which indicates that the further coding unit (C10) is assigned to a data packet (P1) whose identifier (K) was not so far identifiable by the receiver.

16. A communications system with a transmitter (BS) and a receiver (MS) for transmitting data in packet form,
with a unit (U1) for assigning an identifier (K) to each of the data packets (Pi), to identify their order,
with a unit (U2) for coding the data packets (Pi) into coding units (Ci),
whose transmitter (BS) has a unit (U3) for transmitting the coding units (Ci) with the identifier (K) of the associated data packet (Pi),
whose receiver (MS) has a unit (U4) for evaluating the identifier (K) of each coding unit (Ci),
whose receiver (MS) has a memory (U5) for storing one of the coding units (Cl) whose identifier cannot be identified by the evaluation unit (U4),
whose receiver (MS) has a decoder (U6) for decoding the stored coding unit (Cl) using data to be subsequently transmitted by the transmitter (BS),
and whose receiver (MS) has a unit for transmitting information (I), it being possible to infer from the information (I) that the receiver could not identify the identifier (K) of a received coding unit (C1).

17. A receiver (MS) for a communications system for the transmission of data packets (Pi),
which are each assigned an identifier (K) to identify their order,
which are coded into coding units (Ci),
and whose coding units (Ci) are transmitted
from the transmitter (BS) to the receiver (MS) with the identifier (K) of the associated data packet (Pi),
with the following features:
a unit (U4) to evaluate the identifier (K) of each received coding unit (Ci),
a memory (U5) for storing the coding units whose identifier cannot be identified by the evaluation unit (U4),
a decoder (U5) for decoding the stored coding unit (C1) using data to be subsequently transmitted by the transmitter (BS),
and a unit for transmitting information (I), it being possible to infer from the information (I) that the receiver could not identify the identifier (K) of a received coding unit (C1).
